(19) United States
(12) Patent Application Publication
(10) Pub. No.: US 2017/0183163 A1
(43) Pub. Date: Jun. 29, 2017

(54) Belt Conveyor with Wedge Elements for Changing Curvature at Deflection Wheels

(71) Applicant: SIG Technology AG, Neuhausen am Rheinfall (CH)

(72) Inventors: Bernd VON BIRGELEN, Waldfeucht (DE); Markus KLAUS, Eschweiler (DE); Werner SEICHE, Bergheim (DE)

(21) Appl. No.: 15/322,772

(22) PCT Filed: Jun. 24, 2015
(86) PCT No.: PCT/EP2015/064205

§ 371 Date: Dec. 29, 2016

(30) Foreign Application Priority Data
Jun. 30, 2014 (DE) 10 2014 109 157.4

(51) Int. Cl. B65G 21/22; B65G 15/60; B65G 23/02

(52) U.S. Cl. CPC B65G 21/22; B65G 23/02; B65G 15/60; B65G 2201/0202

(57) ABSTRACT

A device for transporting objects: including at least two rotatably mounted wheels for driving and deflecting a conveyor belt, a closed conveyor belt and several cells for receiving the objects to be transported. The cells are connected to the conveyor belt such that their cell centers define a closed transport path. The conveyor belt is guided around the wheels in such a way that the transport path has an approximately circular section in the region of the wheels and an approximately straight section between the wheels. The device further includes an element for changing the curvature of the transport path in between at least one straight path section and at least one circular path section.

The invention relates to a device for transporting objects, particularly for transporting packages for food products, comprising: at least two rotatably mounted wheels for driving and/or for deflecting a conveyor belt, a closed conveyor belt and several cells for receiving the objects to be transported, wherein the cells are connected to the conveyor belt and their cell centers define a closed transport path, and wherein the conveyor belt is guided around the wheels in such a way that the transport path respectively comprises an approximately circular path section in the region of the wheels and respectively comprises an approximately straight path section in the region between the wheels.

The invention furthermore pertains to the use of such a device in the packaging of food products.

Numerous devices and methods for transporting objects are known from practical applications. Transport devices utilizing a revolving conveyor band or a revolving conveyor belt are widely used. Such transport devices have the advantage that the conveyor band or the conveyor belt can be used for accommodating the objects to be transported, as well as for transmitting the motive power. The objects to be transported may either be directly placed onto the conveyor band or the conveyor belt or moved along by “cells” or “pockets” that are fixed on the conveyor band or the conveyor belt.

Many transport devices comprise several transport bands or conveyor belts that may be arranged, for example, successively referred to the transport direction. This allows the transport over great distances, as well as a simple change of the transport direction.

Transport devices used for transporting sensitive objects such as, for example, food products are subject to special requirements. Significant accelerations should be prevented, in particular, because they can cause damages to the food products or their packages. Another problem in the packaging of food products can be seen in that excessive accelerations can cause the contents placed into the packages to be thrown out of the still unsealed packages again and thusly soil the packaging system. This problem arises, in particular, with liquid food products such as fruit juices, milk or yogurt.

In transport devices, it is generally attempted to achieve high operating speeds such that reducing objectionable accelerations by slowing down the operation is out of the question. The accelerations should instead be reduced in a different way. According to the fundamental laws of mechanics, accelerations always occur when the direction or the magnitude of the transport speed changes.

Transport devices with conveyor belts or conveyor bands frequently have a transport path that comprises several straight path sections in the region of the free extent of the conveyor belts or conveyor bands and several circular path sections in the region of the deflection of the conveyor belts or conveyor bands. At a constant transport speed, no acceleration occurs during a translatory motion along the straight path sections. However, an acceleration occurs during a rotatory motion along the circular path sections, namely even at a constant (angular) speed, because the direction of the speed continuously changes in the region of these path sections. The accelerations in the region of the circular path sections can be limited to an acceptable level by choosing a sufficiently large radius.

The transitions from the straight path sections to the circular path sections and, vice versa, from the circular path sections to the straight path sections proved to be particularly problematic. “Tangential” transitions typically exist between the straight path sections and the circular path sections because this type of transition automatically ensues when a conveyor belt or a conveyor band is tensioned around two (or more) driving wheels or deflection wheels. Tangential transitions in fact can be constructively realized in a particularly simple fashion; however, they have the disadvantage that the objects to be transported are subjected to significant acceleration in the region of the tangential transitions. The reason for this can be seen in the abrupt change of the curvature that amounts to zero in the region of the straight path sections and has a constant value in the region of the circular path sections. A tangential transition from a straight path section to a circular path section therefore results in an abrupt increase of the curvature of the transport path whereas a tangential transition from a circular path section to a straight path section results in an abrupt decrease of the curvature of the transport path. In both instances, the abrupt change of curvature results in significant accelerations and therefore jerky stresses.

The phenomenon of significant accelerations at “tangential” transitions between straight path sections and circular path sections has resulted in different constructive and planning-related solutions in the construction of roads and railways. One solution consists of providing a so-called “track transition curve” as connecting element between a straight path section and a circular path section. The track transition curve has—in contrast to straight and circular path sections—no constant curvature radius, but rather a variable curvature radius. Consequently, a “smooth” transition between a straight and a circular path section can be achieved by means of a track transition curve. Different solutions with respect to the exact geometric design of track transition curves are available.

The principle of track transition curves has already been applied to packaging systems for food products as well. For example, U.S. Pat. No. 3,771,574 A describes a filling machine with a track transition curve. According to the solution described in this publication, the containers to be transported, which consist of cans in this case, are initially transferred to a first, small transport wheel with pockets by a rotating screw conveyor. Subsequently, the cans are transferred from the small transport wheel to a second, larger transport wheel that also features pockets for guiding the cans. Both transport wheels have outwardly arranged circular guide rails that are intended to prevent the cans from sliding out of the pockets.

The large transport wheel ultimately transfers the cans to a straight conveyor belt that likewise features pockets for guiding the cans.

During the transition between the second transport wheel and the conveyor belt, the cans should follow a track transition curve with changing curvature. This is achieved by increasing the curvature of the guide rail, which is initially constant and adapted to the large transport wheel, such that the cans are no longer moved along a circular path with constant radius, but rather along a curve with increasing radius, and ultimately transferred to the conveyor belt. For this purpose, the conveyor belt is not arranged tangentially relative to the second transport wheel, but rather outwardly offset.

The solution described in U.S. Pat. No. 3,771,574 A has the advantage that an optimized transport path with respect to the theoretically occurring accelerations is realized in the region of the transition between the second transport wheel and the conveyor belt with the aid of the track transition curve. However, it is disadvantageous that the cans should also be transferred from one transport means (the second transport wheel) to another transport means (the conveyor belt) at the transition from a circular path section to a straight path section. In practical applications, this results in the cans still being subjected to undesirable accelerations at the moment of the transfer due to vibrations or speed differentials between the two transport means. In the region of the track transition curve, the distance of the guide rail from the transport wheel increases such that the cans have an increasing track speed at a constant angular speed due to the increasing radius and therefore are subjected to an undesirable acceleration in the transport direction. In addition, it is practically impossible to exactly adapt the increasing track speed to the constant speed of the pockets of the conveyor belt such that the risk of jerky stresses also exists during the transfer of the cans from the second transport wheel to the conveyor belt.

The invention therefore is based on the objective of designing and enhancing a device of the initially cited and above-described type in such a way that objectionable accelerations of the objects to be transported, particularly at transitions between straight path sections and circular path sections, are additionally reduced.

In a device according to the preamble of claim 1, this objective is attained with a means for changing the curvature of the transport path in the region between at least one straight path section and at least one circular path section.

The device is initially characterized by at least two rotatably mounted wheels for driving and/or for deflecting the conveyor belt. The wheels therefore serve for driving and/or deflecting the conveyor belt, wherein the drive may be realized, for example, positively or non-positively, particularly in the form of a toothing. The wheels are preferably realized circularly. In addition, the device is provided with a closed conveyor belt, wherein this term may also refer, for example, to conveyor bands or conveyor chains. It would likewise be conceivable to utilize a particularly cost-efficient alternative in the form of a rope drive. In a particularly simple embodiment, the rope drive may be realized in the form of an endless closed rope. However, a more stable solution consists of a finitely extending rope that is spirally wound in several layers and connected in itself at the same or different locations by the mounting of the cells. Very high tensile forces can be transmitted with rope drives, particularly if they consist of rope drives in the form of ropes that are spirally wound in several layers. Conveyor belts, in contrast, are significantly less sensitive to inclinations. With respect to an aseptic design, a conveyor belt is far superior to a rope drive. The term closed conveyor belt refers to a revolving conveyor belt without beginning and end, i.e. an “endless” conveyor belt. The device furthermore comprises several cells for receiving the objects to be transported. For example, the objects may be simply placed, clamped or suspended in the cells for their transport. In order to manage suddenly occurring accelerations, it is also particularly advantageous to fix the objects in the cells in such a way that they cannot carry out any motion relative to the cell on at least a section of the transport path in the normal operating mode of the device. In the transport of packages for food products, this section preferably consists of the section between the point, at which the filling process is completed, and the point, at which the package is sealed, because this is the region, in which the objects react most sensitively to sudden or jerky accelerations. The cells of the device are connected to the conveyor belt. Since the cell centers approximately correspond to the centers of the transported objects, particularly their centers of gravity, a path extending through the cell centers of all cells approximately corresponds to the transport path of the transported objects. In practical applications, however, the centers of gravity of the transported objects in fact do not always exactly coincide with the cell centers; however, they frequently lie vertically underneath or above the cell centers. In this case, the vertical offset between the centers of gravity of the transported objects and the cell centers is mathematically irrelevant for the extent of the transport path. The centers of gravity of the transported objects also may slightly deviate from the cell centers in the horizontal direction. This may occur, for example, due to an inclination of the transported objects or due to a motion of the contents of the transported objects (e.g. packages with liquid content). However, these deviations are so small that they are negligible. The cell centers therefore describe or define the transport path. The term closed transport path refers to a revolving transport path without beginning and end, i.e. an “endless” transport path. In the device, the conveyor belt is guided around the wheels in such a way that the transport path respectively comprises an approximately circular path section in the region of the wheels and an approximately straight path section between the wheels.

According to the invention, the device comprises means for changing the curvature of the transport path in the region between at least one straight path section and at least one circular path section. A uniform transition, in particular, between the curvature of the circular path section and the (nonexistent) curvature of the straight path section should be achieved due to the change of the curvature. The curvature of the transport path can be changed or influenced in different ways. Since the objects are in the described device transported in cells, the path of the cells also defines the transport path of the transported objects. The path of the cells can either be influenced in that the cells change their distance relative to the conveyor belt, on which they are fixed. The path of the cells may alternatively or additionally be influenced in that the position or the extent of the conveyor belt itself is changed. A purposeful change of the curvature of the transport path in the region between at least one straight path section and at least one circular path section particularly makes it possible to prevent an abrupt increase of the curvature or an abrupt decrease of the curvature as it occurs, for example, in a tangential transition between straight and circular path sections.

According to an embodiment of the device, it may comprise means for changing the curvature of the transport path in the region between each straight path section and each circular path section. Due to this design, abrupt changes of the curvature of the transport path and associated accelerations of the transported objects not only are effectively prevented at particularly critical transitions, but rather at each transition between straight and circular path sections. This has the effect, for example, that the device can also be used for transporting particularly sensitive objects such as, for example, food products.

Another embodiment of the device is characterized by means for changing the curvature of the conveyor belt in the region between at least one straight path section and at least one circular path section. This embodiment is based on the notion of indirectly changing or influencing the transport path of the transported object—which is defined by the path of the cells—by changing the extent of the conveyor belt. This is possible because the cells are connected to the conveyor belt and a motion of the conveyor belt therefore can be quite easily transmitted to the cells. This embodiment has the particular advantage that the cells can be rigidly connected to the conveyor belt and do not have to change their position relative to the conveyor belt.

Another embodiment of the device is characterized by means for changing the curvature of the conveyor belt in the region between each straight path section and each circular path section. This embodiment also not only effectively prevents abrupt changes of the curvature of the transport path and associated accelerations of the transported objects at particularly critical transitions, but rather at each transition between straight and circular path sections. This has the effect, for example, that the device can also be used for transporting particularly sensitive objects such as, for example, food products.

According to another embodiment of the device, it is proposed that the means for changing the curvature of the conveyor belt is realized in the form of a wedge element. A wedge-shaped element can be manufactured in a particularly simple fashion and is especially suitable for use in the region of transitions from straight to circular path sections due to its shape. The acute angle of the wedge element can be very easily pushed between one of the wheels and the conveyor belt revolving around this wheel in order to guide the conveyor belt away from the wheel and to thusly change the route of the conveyor belt—in accordance with the shape of the wedge element. For this purpose, the wedge element preferably is stationarily mounted closely in front of the rotating wheel such that the conveyor belt is guided over the wedge element and slides thereon. The wedge element preferably is separably connected to the device such that it can be easily exchanged. This may be necessary, for example, when the wedge element is worn out or when a wedge element with a differently shaped outer side should be used in order to change the extent of the conveyor belt sliding on the outer side. The wedge element is preferably made of plastic, particularly of PEEK (polyetheretherketone), POM (polyoxymethylene), PETP (polyethylene terephthalate) or other materials suitable for slideways.

With respect to this embodiment, it is furthermore proposed that the wedge element has an inner side assigned to the wheel and an outer side assigned to the conveyor belt. Wedge-shaped elements typically have two lateral surfaces. Due to the flat design of the wedge element, one lateral surface (the inner side) can be assigned to the wheel and its shape can be adapted to the shape and curvature of the wheel. In this way, the wedge element can be arranged very precisely and closely in front of the wheel; in addition, accidental incorrect mounting of the wedge element on a wheel with a different curvature is prevented. Due to the flat design of the wedge element, the outer lateral surface (the outer side) furthermore can be assigned to the conveyor belt and its shape and curvature can be adapted to the route to be assumed by the conveyor belt.

With respect to the wedge element, another embodiment of the device proposes that the outer side of the wedge element has a curvature that monotonically increases in the direction of the transport path or a curvature that monotonically decreases in the direction of the transport path. The curvature may in particular increase in a strictly monotonic or decrease in a strictly monotonic fashion. In this way, the conveyor belt sliding on the outer side of the wedge element can also have a monotonically increasing curvature or a monotonically decreasing curvature. Due to the monotonic increase or monotonic decrease of the curvature, a particularly smooth transition between different curvatures such as, for example, between the curvature in the region of a circular path section and the (nonexistent) curvature in the region of a straight path section can be achieved over a short distance.

According to another embodiment of the device, it is proposed that the outer side of the wedge element has on one side a curvature corresponding to the transport path in the region of one of the circular path sections and on the other side no curvature at all. Due to this design, a steady and therefore particularly smooth transition of the curvature between a circular path section and a straight path section is achieved. In other words, the wedge element can be optimized for use with a wheel that has a certain radius or a certain curvature.

According to another embodiment of the device, it is proposed that the outer side of the wedge element has a length in the range between 100 mm and 700 mm, particularly between 100 mm and 500 mm, in the direction of the transport path. If the length of the outer side of the wedge element lies in this range, it represents a good compromise between a compact design (short length) and a particularly slow change of the curvature (great length). Since the shape of the wedge element roughly corresponds to a circular arc, the length of its outer side may also be defined by an angular range around the center of the wheel, in front of which the wedge element is mounted. The angular range may lie between 10° and 30°.

According to another embodiment of the device, it is proposed that the outer side of the wedge element has the shape of a curve, the curvature of which is proportional to its length. It is particularly proposed that the outer side of the wedge element has the shape of a curve, the curvature of which is at each point of proportional to the distance traveled along the curve up to this point. In mathematics, such a curve is also referred to as a “clothoid” or “Euler spiral” or . Clothoids are characterized in that their curvature linearly increases (κ(s)=a*s; κ=curvature, a=parameter, s=distance traveled up to this point of the function (arc length)). Since the shape of the outer side of the wedge element also defines the extent of the transport path in the region of the wedge element, a clothoid makes it possible to achieve a linear increase or a linear decrease of the curvature of the transport path in the region between a straight path section and a circular path section. The change of the curvature over the entire path length ((κ(s=L)−(κ(s=0))*L; L=overall length of the curve) may lie in the range between 0.05 and 1.00.

It is alternatively proposed that the outer side of the wedge element has the shape of a curve, the curvature of which is proportional to its angle of rotation. It is particularly proposed that the outer side of the wedge element has the shape of a curve, the curvature of which is at each point proportional to its angle of rotation up to this point. The description of the curve in dependence on an angle of rotation is advantageous in this case because the wedge element is mounted in front of a circular body, namely one of the wheels, such that the outer side of the wedge element can be roughly considered to be a circular arc and the center of the wheel can be roughly considered to be the center of the circle. In mathematics, such a curve is also referred to as a “Archimedean spiral.” Archimedean spirals are characterized in that their radius and therefore also their curvature increases or decreases proportionally to the angle of rotation (R=a*φ; R=radius, a=factor, φ=angle of rotation). Since the shape of the outer side of the wedge element also defines the extent of the transport path in the region of the wedge element, a clothoid makes it possible to achieve a nearly linear increase or a nearly linear decrease of the curvature of the transport path in the region between a straight path section and a circular path section.

According to another embodiment of the device, it is proposed that the outer side of the wedge element has the shape of a polynomial. It is particularly proposed that the outer side of the wedge element has the shape of a polynomial of the third or a higher degree, particularly of the fifth or a higher degree. This design is based on the realization that the rate of change of the curvature (it defines the change of the acceleration, i.e. the “jerk”) particularly can be adjusted lower at the two ends of the wedge element, i.e. at the transitions from the straight path section to the circular path section, than in the center of the wedge element such that the objects can be guided over the two ends of the wedge element in a particularly smooth fashion. The nonlinear change of the curvature over the entire path length ((κ(s=L)−(κ(s=0))*L; L=overall length of the curve) may lie in the range between 0.05 and 1.00.

According to another embodiment of the device, it is proposed that the wedge element has at least one finger. It is preferred to provide two or more fingers. In this context, the term finger refers to an elongate section that is suitable for being inserted into a groove provided on one of the wheels. In this way, the wedge element also can still be supported by means of the fingers in a region, in which the conveyor belt already no longer extends over the outer side of the wedge element. This allows very precise positioning of the wedge element and therefore particularly seamless transitions.

According to another embodiment of the device, it is proposed that the conveyor belt is in the region of at least one straight path section outwardly offset relative to a tangential connection between the two adjacent wheels by a distance between 5 mm and 100 mm. This outward offset makes it possible to achieve a smooth transition between a circular path section and a straight path section. The decrease of the curvature of the circular path section inevitably results in an increase of the radius of this path section and therefore in an outward “offset.”

According to another embodiment of the device, it is proposed that the means for changing the curvature of the transport path is realized in the form of an adjustable arm, by means of which the cell is connected to the conveyor belt. Alternatively to the wedge element, the curvature of the transport path consequently can also be changed with a different means, namely an adjustable arm. An adjustable arm makes it possible to change the distance between the cell and the conveyor belt such that the distance between the transport path—that extends through the centers of the cells—and the conveyor belt can also be changed. In this way, optimized transitions of the transport path between straight path sections and circular path sections can also be achieved with a conveyor belt that conventionally extends tangentially. The adjustable arms may also be combined with the wedge elements in order to limit the required travel of the arms. The travel of the adjustable arm may lie between 5 mm and 100 mm. In this context, the term travel refers to the distance between the two maximum positions of the cells, i.e. the distance between the retracted position (cell very close to the conveyor belt) and the extended position (cell not as close to the conveyor belt).

All embodiments of the above-described device are particularly well suited for use in the packaging of food products. The reason for this particularly can be seen in that food products are frequently very sensitive and therefore need to be transported in a particularly gentle fashion. In the packaging of food products, there also arise situations, in which the food products have already been placed into a package, but the package has not yet been sealed. These situations require a particularly gentle transport in order to prevent the food products from falling or flowing out of the still unsealed packages.

The invention is described in greater detail below with reference to the drawings that merely show a preferred exemplary embodiment. In these drawings,

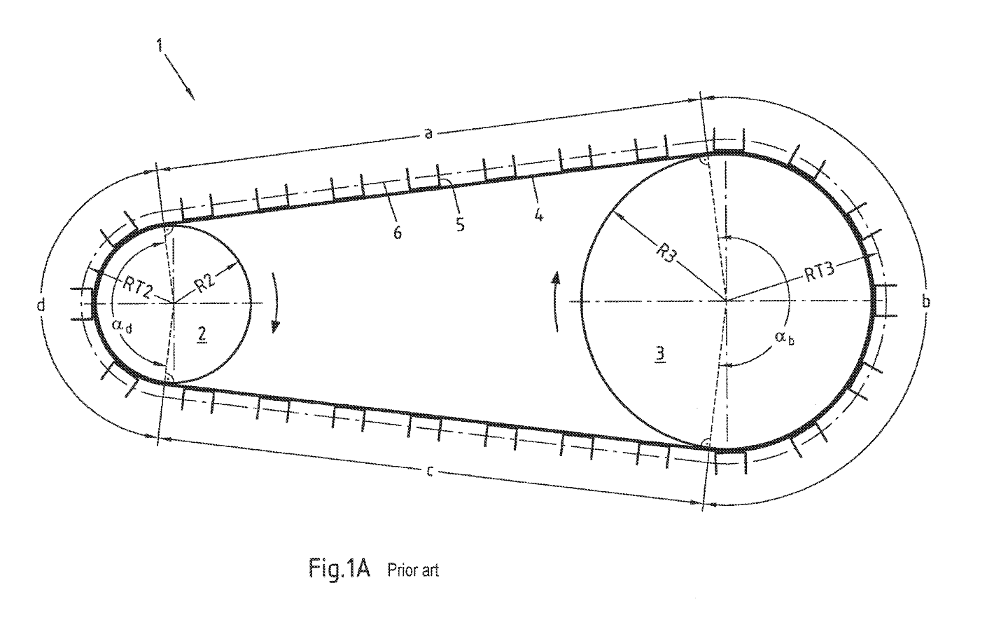

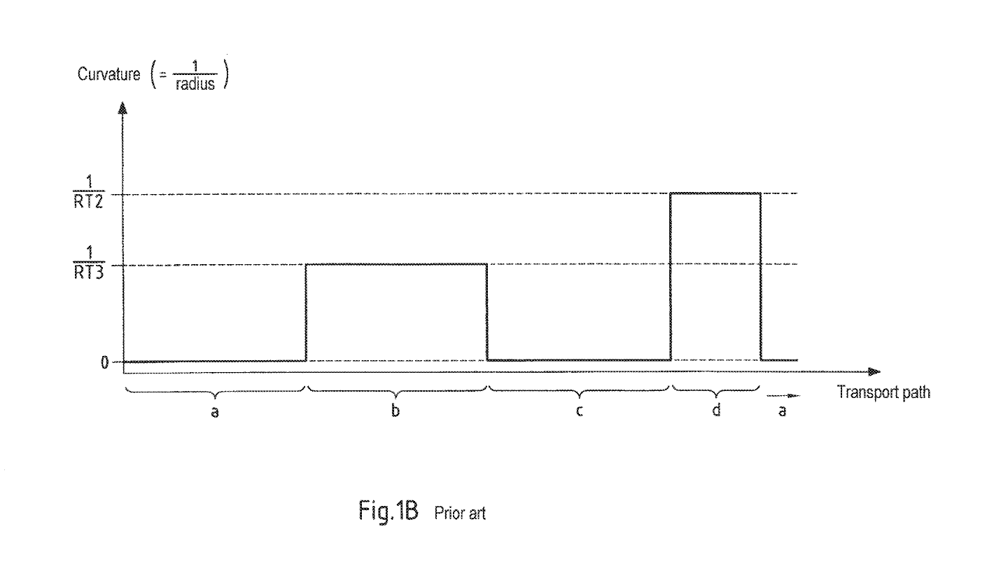

FIG. 1A shows a top view of a device for transporting objects according to the prior art,

FIG. 1B shows the progression of the curvature along the transport path in the device according to FIG. 1A,

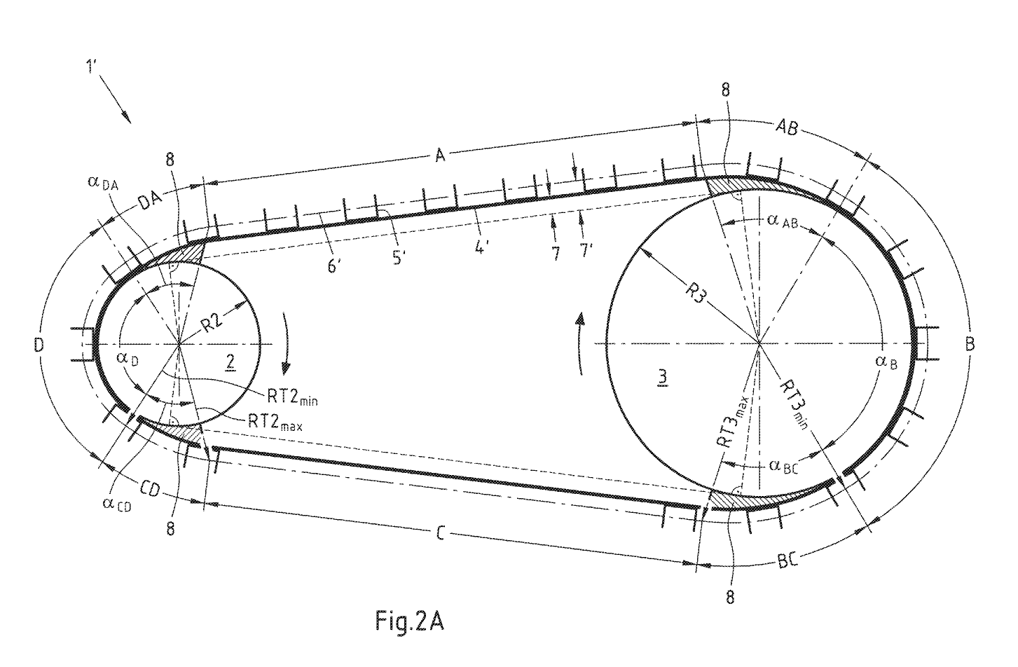

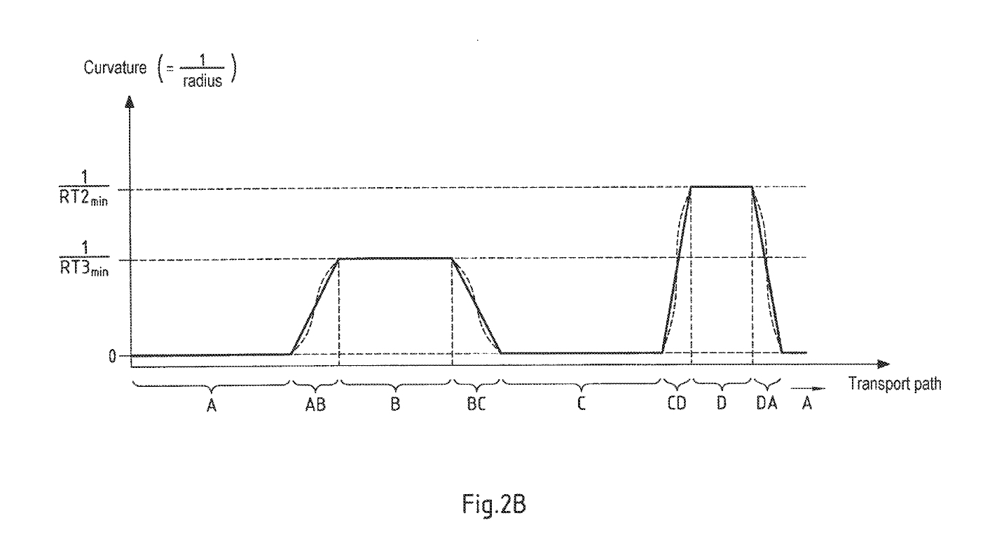

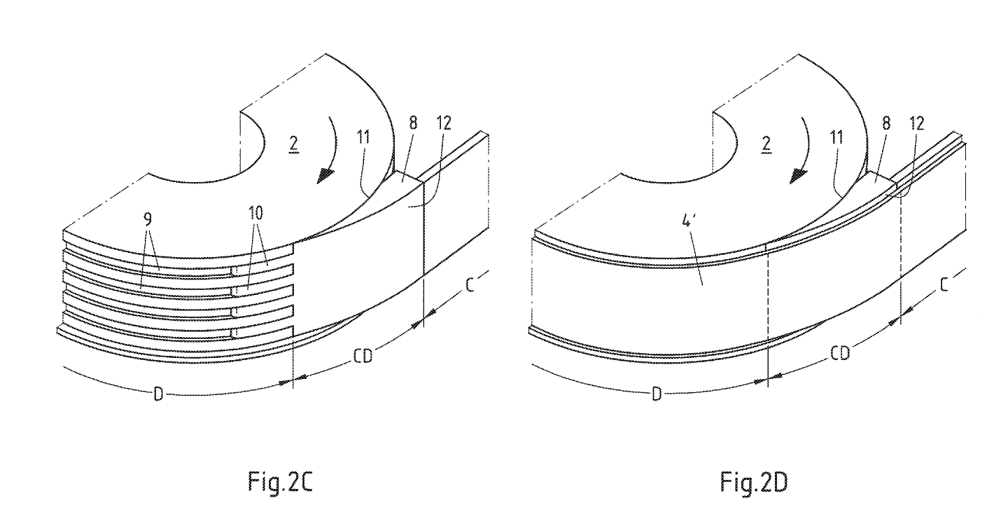

FIG. 2A shows a top view of a first embodiment of an inventive device for transporting objects,

FIG. 2B shows the extent of the curvature along the transport path in the device according to FIG. 2A,

FIG. 2C shows an enlarged view of the transition between a circular path section and a straight path section in the device according to FIG. 2A without the conveyor belt,

FIG. 2D shows an enlarged view of the transition between a circular path section and a straight path section in the device according to FIG. 2A with the conveyor belt,

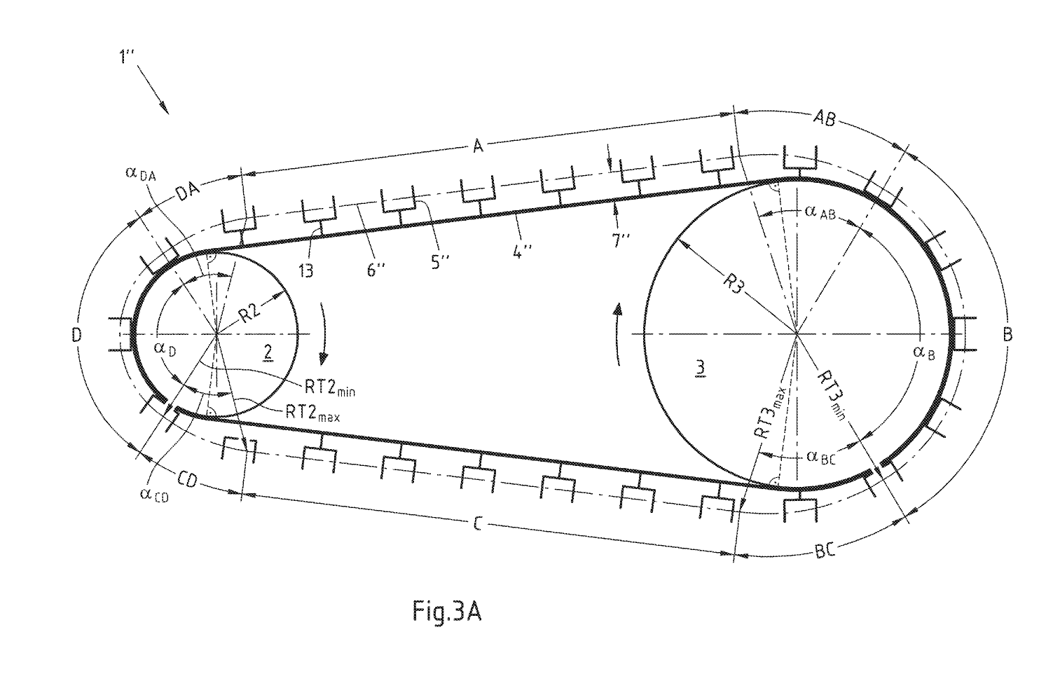

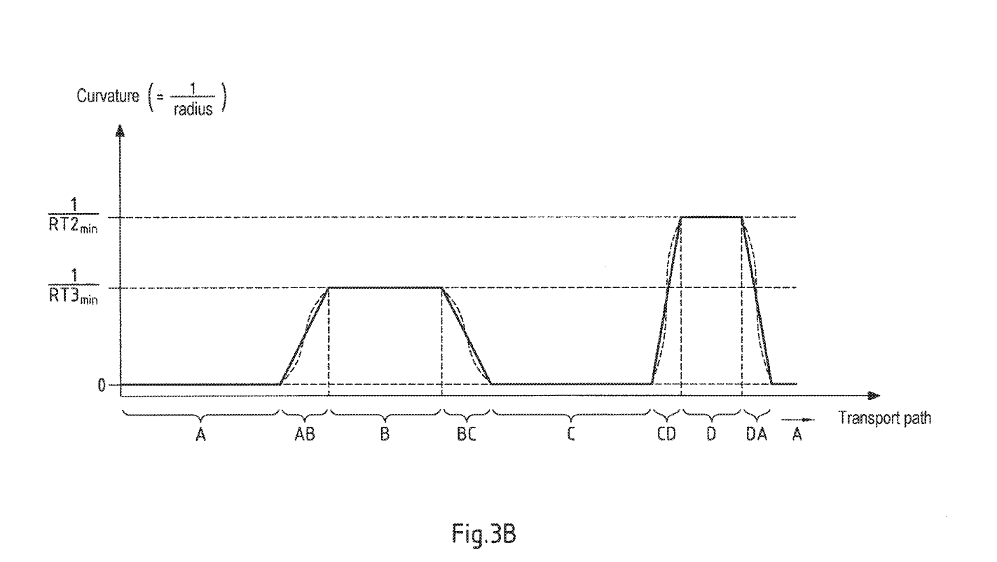

FIG. 3A shows a top view of a second embodiment of an inventive device for transporting objects, and

FIG. 3B shows the progression of the curvature along the transport path in the device according to FIG. 3A.

FIG. 1A shows a top view of a device 1 for transporting objects according to the prior art. The device 1 comprises two wheels 2, 3, around which a conveyor belt 4 is guided. Cells 5 capable of receiving the objects to be transported are equidistantly arranged on the conveyor belt 4. The objects transported in the cells 5 therefore move along a path that extends through the centers of the cells 5 and is referred to as transport path 6. The larger wheel 3 has a radius R3 and drives the conveyor belt 4; the smaller wheel 2 has a radius R2, wherein this smaller wheel merely deflects and is turned by the conveyor belt 4. For example, the two wheels 2, 3 rotate in the clockwise direction (indicated with arrows in FIG. 1A).

In the device 1 illustrated in FIG. 1A, the transport path 6 to be traveled by the transported objects is composed of four sections: the path section a extends straight from the small wheel 2 to the large wheel 3. The path section b, in contrast, extends circularly around the wheel 3 over an angle α_{b} with a radius RT3 that is slightly larger than the radius R3. The path section c once again extends straight from the large wheel 3 back to the small wheel 2. The path section d ultimately extends circularly around the wheel 2 over an angle α_{d} with a radius RT2 that is slightly larger than the radius R2. The end of the path section d is once again followed by the beginning of the path section a such that the path sections a, b, c, d jointly form a revolving and closed transport path 6. The two straight path sections a, c lie on tangents on the circles formed by the wheels 2, 3. In the device 1 illustrated in FIG. 1A, the two straight path sections a, c and the two circular path sections b, d therefore tangentially transform into one another. Since the left wheel 2 is smaller than the right wheel 3, the angle α_{d} is also smaller than the angle α_{b}; however, the sum of the two angles amounts to 360°—as it is always the case with two wheel wrap angles.

FIG. 1B shows the progression of the curvature along the transport path 6 in the device 1 according to FIG. 1A. In this diagram, the transport path 6 is illustrated on the horizontal axis whereas the curvature of the transport path 6 is illustrated on the vertical axis. The curvature corresponds to the reciprocal value of the radius. According to this diagram, the curvature of the first path section a amounts to zero because the path section a is a straight path section. At the transition from the path section a to the path section b, the curvature of the transport path 6 abruptly increases to a value 1/RT3 that corresponds to the curvature of the transport path 6 in the region of the circular path section b. At the transition from the path section b to the path section c, the curvature of the transport path 6 once again decreases just as abruptly to a value zero that corresponds to the curvature in the region of the straight path section c. At the transition from the path section c to the path section d, the curvature of the transport path 6 once again abruptly increases to a value 1/RT2 that corresponds to the curvature of the transport path 6 in the region of the circular path section d. Subsequently, the curvature of the transport path 6 once again decreases just as abruptly to a value zero that corresponds to the curvature in the region of the straight path section a.

The progression of the curvature illustrated in FIG. 1B reveals that four abrupt changes of the curvature of the transport path 6 occur during one complete revolution of the conveyor belt 4, namely at each transition between a straight path section a, c and a circular path section b, d. Since a change of the curvature of the transport path 6 always results in an acceleration of the transported objects—as already described initially—significant accelerations, as well as jerky loads, occur in the device 1 illustrated in FIG. 1A at the transitions between the straight path sections a, c and the circular path sections b, d due to the abrupt changes of the curvature of the transport path 6.

FIG. 2A shows a top view of a first embodiment of an inventive device 1′ for transporting objects. The device 1′ illustrated in FIG. 2A and the above-described device 1 according to FIG. 1A have a few similarities such that the parts of the device illustrated in FIG. 2A, which were already described above in connection with FIG. 1A and FIG. 1B, are identified by corresponding reference symbols. The device 1′ also comprises two wheels 2, 3, around which a—differently running—conveyor belt 4′ is guided. Cells 5′ capable of receiving the objects to be transported are once again equidistantly arranged on the conveyor belt 4′. A transport path 6′ extends through the centers of the cells 5′. The larger wheel 3 has a radius R3 and drives the conveyor belt 4′; the smaller wheel 2 has a radius R2, wherein this smaller wheel merely deflects and is turned by the conveyor belt 4′. For example, the two wheels 2, 3 also rotate in the clockwise direction (indicated with arrows in FIG. 2A) in this case.

One distinction between the device 1′ illustrated in FIG. 2A and the above-described device 1 (FIG. 1A) can be seen in an optimized transport path 6′: the transport path 6′ to be traveled by the transported objects is now composed of eight sections: the path section A extends straight from the small wheel 2 to the large wheel 3. The next path section AB, in contrast, extends spirally over an angle α_{AB} and at the beginning has a radius RT3ₘₐₓ that continuously decreases to a radius RT3ₘᵢₙ. The path section AB transforms into a path section B that circularly extends around the wheel 3 over an angle α_{B} with the radius RT3ₘᵢₙ. This path section is followed by a path section BC that extends spirally over an angle α_{BC} and at the beginning has the radius RT3ₘᵢₙ that continuously increases to the radius RT3ₘₐₓ. The following path section C once again extends straight from the large wheel 3 back to the small wheel 2. The next path section CD once again extends spirally over an angle α_{CD} and at the beginning has a radius RT2ₘₐₓ that continuously decreases to a radius RT2ₘᵢₙ. The path section CD transforms into a path section D that circularly extends around the wheel 2 over an angle α_{D} with the radius R2. This path section is followed by another path section DA that spirally extends over an angle α_{DA} and at the beginning has the radius RT2ₘᵢₙ that continuously increases to the radius RT2ₘₐₓ. The end of the path section DA is once again followed by the beginning of the path section A such that the path sections A, AB, B, BC, C, CD, D, DA jointly form a complete revolving and closed transport path 6′. For example, the spirally extending path sections AB, BC, CD and DA may have the shape of a clothoid.

In the device 1′ illustrated in FIG. 2A, the conveyor belt 4′ runs—in contrast to the device 1 according to FIG. 1A—no longer on tangents on the circles formed by the wheels 2, 3 in the region of the two straight path sections A and C. Instead, the conveyor belt 4′ is arranged outside these tangents and has an offset 7 relative thereto (the extent of the tangents is illustrated with broken lines in FIG. 2A) in the region of the two straight path sections A and C. This route of the conveyor belt 4′ is achieved, for example, with wedge elements 8 that are described in greater detail below in connection with FIG. 2C and FIG. 2D. The offset 7 may lie in the range between 5 mm and 100 mm. In addition, an offset 7′ is created between the transport path 6′ and the tangents, wherein this offset may lie in the range between 10 mm and 130 mm and therefore is—depending on the cell mounting—slightly larger than the offset 7 between the conveyor belt 4′ and the tangents. The offset 7 and the offset 7′ may be constant (R2ₘₐₓ=R3ₘₐₓ) or variable (R2ₘₐₓ≠R3ₘₐₓ) in the straight path sections A, C. The angles α_{AB}, α_{BC}, α_{CD} and α_{DA} of the spirally extending path sections AB, BC, CD and DA may lie in the range between 10° and 30°.

FIG. 2B shows the progression of the curvature along the transport path 6′ in the device 1′ according to FIG. 2A. In this diagram, the transport path 6′ is—analogous to FIG. 1B—illustrated on the horizontal axis whereas the curvature of the transport path 6′ is illustrated on the vertical axis. The curvature corresponds to the reciprocal value of the radius. According to this diagram, the curvature of the first path section A amounts to zero because the path section A is a straight path section. At the transition from the path section A to the path section B, the curvature of the transport path slowly increases in the region of the path section AB to a value 1/RT3ₘᵢₙ that corresponds to the curvature of the transport path 6′ in the region of the circular path section B. The curvature may increase in a linear (continuous line) or polynomial (broken line) fashion. At the transition from the path section B to the path section C, the curvature of the transport path 6′ once again decreases just as slowly in the region of the path section BC to a value zero that corresponds to the curvature in the region of the straight path section C. The curvature may also decrease in a linear (continuous line) or polynomial (broken line) fashion. At the transition from the path section C to the path section D, the curvature of the transport path 6′ once again slowly increases in the region of the path section CD to a value 1/RT2ₘᵢₙ that corresponds to the curvature of the transport path 6′ in the region of the circular path section D. This increase may also take place in a linear (continuous line) or polynomial (broken line) fashion. Subsequently, the curvature of the transport path slowly decreases in the region of the path section DA to a value zero that corresponds to the curvature in the region of the straight path section A. This decrease of the curvature may likewise take place in a linear (continuous line) or polynomial (broken line) fashion.

The progression of the curvature illustrated in FIG. 2B reveals that abrupt changes of the curvature of the transport path 6′ no longer occur in the device 1′. Due to the design of the path sections AB, BC, CD and DA, the curvature is instead uniformly and slowly adapted to the curvature of the following path section in the “critical” regions, namely at each transition between a straight path section A, C and a circular path section B, D. Since a change of the curvature of the transport path 6′ always results in an acceleration of the transported objects—as already described initially—the accelerations occurring in the device 1′ illustrated in FIG. 2A at the transitions between the straight path sections A, C and the circular path sections B, D are significantly reduced in comparison with the device 1 illustrated in FIG. 1A.

FIG. 2C shows an enlarged view of the transition between a circular path section and a straight path section in the device 1′ according to FIG. 2A without the conveyor belt. The transition shown consists of the transition between the circular path section D and the straight path section C formed by the path section CD. This figure shows the wheel 2 that features several continuous grooves 9 on its circumference. In addition, one of the aforementioned wedge elements 8 is provided in the path section CD, wherein said wedge element features several protruding fingers 10 that engage into the grooves 9 of the wheel 2. In this way, the conveyor belt 4′ can be guided without jerks in the described transition. Since the outer surface of the wedge element 8 represents part of the guideway of the conveyor belt 4′, the wedge element 8 is during the operation subjected to considerable tension that is absorbed by the fingers 10, in particular, in the outlet region of the wedge element 8 (at the location, at which the wedge element 8 is tapered like a blade). The wedge element 8 also has an inner side 11 assigned to the wheel 2 and an outer side 12 assigned to the conveyor belt 4′ (that is not illustrated in FIG. 2C). The inner side 11 of the wedge element 8 preferably has a circular shape and a radius that approximately corresponds to the radius R2 of the wheel 2 assigned thereto. The outer side 12 of the wedge element 8, in contrast, has an increasing curvature referred to the transport direction. It is preferred that the curvature of the outer side 12 approximately corresponds to zero on the side assigned to the straight path section C and approximately reaches the curvature of the transport path 6′ in the region of the circular path section D (1/RT2ₘᵢₙ) on the side assigned to the circular path section D.

FIG. 2D shows an enlarged view of the transition between a circular path section and a straight path section in the device 1′ according to FIG. 2A with the conveyor belt 4′. The illustration in FIG. 2D can be distinguished from the illustration in FIG. 2C, in particular, in that the revolving conveyor belt 4′ is installed. However, the cells 5 are not illustrated in order to provide a better overview. According to this figure, the conveyor belt 4′ is guided over the stationary wedge element 8 and slides thereon in the region of the path section CD. In this way, the conveyor belt 4′ assumes the shape of the outer side 12 of the wedge element 8 in the region of the path section CD. Consequently, the extent of the conveyor belt 4′—and therefore also of the transport path 6′—can be sectionally defined by the shape of the wedge element 8, particularly the shape of its outer side 12.

FIG. 3A shows a top view of a second embodiment of an inventive device 1″ for transporting objects. The areas of the device, which were already described in connection with FIG. 1A to FIG. 2D, are identified by corresponding reference symbols in FIG. 3A. One significant distinction between the device 1″ illustrated in FIG. 3A and the above-described device 1′ can be seen in that the cells 5″ are connected to the conveyor belt 4″ by means of arms 13 that can be adjusted during the operation of the device 1″. Consequently, the distance between the conveyor belt 4″ and the cells 5″ can be varied such that the transport path 6″ of the objects transported by the cells 5″ does—in contrast to the above-described device 1′—not necessarily have to extend parallel to the conveyor belt 4″. In this way, an optimized transport path 6″ (as illustrated in FIG. 2A) can also be achieved with a conveyor belt 4″ that has tangential sections (as illustrated in FIG. 1A). The transport path 6″ is also illustrated with broken lines in FIG. 3A; it once again corresponds to the path of the centers of the cells 5″ and is identical to the transport path 6′ illustrated in FIG. 2A—despite the different extent of the conveyor belt 4″. An offset 7″, which may lie in the range between 5 mm and 100 mm, is therefore created between the straight path sections A, C of the transport path 6″ and the tangentially extending conveyor belt 4″. Due to the adjustability of the arms 13, the wedge elements 8 can be eliminated in the device 1″ illustrated in FIG. 3A. However, a combination of wedge element 8 and adjustable arms 13 could conceivably also be used.

FIG. 3B ultimately shows the progression of the curvature along the transport path 6″ in the device 1″ according to FIG. 3A. Due to the identical transport paths 6′ and 6″, FIG. 3B exactly corresponds to FIG. 2B and we therefore refer to the description thereof in this respect.

LIST OF REFERENCE SYMBOLS

1, 1′, 1″: Device for transporting objects

2, 3: Wheel

4, 4′, 4″: Conveyor belt

5, 5′, 5″: Cell

6, 6′, 6″: Transport path

7, 7′, 7″: Offset

8: Wedge element

9: Groove

10: Finger

11: Inner side of wedge element

12: Outer side of wedge element

13: Adjustable arm

A, a, C, c: Straight path section

B, b, D, d: Circular path section

AB, BC, CD, DA: Spirally extending path section

R2: Radius of wheel 2

RT2: Radius of transport path in the region of the wheel 2

RT2ₘᵢₙ: Smallest radius of transport path in the region of the wheel 2

RT2ₘₐₓ: Greatest radius of transport path in the region of the wheel 2

R3: Radius of wheel 3

RT3: Radius of transport path in the region of the wheel 3

RT3ₘᵢₙ: Smallest radius of transport path in the region of the wheel 3

RT3ₘₐₓ: Greatest radius of transport path in the region of the wheel 3

α_{b}: Angular range of path section b

α_{d}: Angular range of path section d

α_{AB}: Angular range of path section AB

α_{B}: Angular range of path section B

α_{BC}: Angular range of path section BC

α_{CD}: Angular range of path section CD

α_{D}: Angular range of path section D

α_{DA}: Angular range of path section DA

1.-15. (canceled)

16. A device for transporting objects comprising:
at least two rotatably mounted wheels for driving and deflecting a conveyor belt,
a closed conveyor belt, and
an element for changing curvature of the conveyor belt in a region between at least one straight path section and at least one circular path section, wherein the element for changing the curvature of the conveyor belt is a wedge,
wherein the conveyor belt is guided around the wheels in such a way that a transport path respectively comprises an approximately circular path section in the region of the wheels and respectively comprises an approximately straight path section in the region between the wheels,
further comprising several cells for receiving the objects to be transported, and wherein the cells are connected to the conveyor belt and centers of each of the several cells define a closed transport path of the objects to be transported, and the wedge element has an inner side that is assigned to the wheel and an outer side that is assigned to the conveyor belt.

17. The device according to claim 16, further comprising an element for changing the curvature of the transport path in between each straight path section and each circular path section.

18. The device according to claim 16, further comprising an element for changing the curvature of the conveyor belt in between each straight path section and each circular path section.

19. The device according to claim 16, wherein the outer side of the wedge element has a curvature that monotonically increases in a direction of the transport path or a curvature that monotonically decreases in the direction of the transport path.

20. The device according to claim 16, wherein the outer side of the wedge element has on one side a curvature corresponding to the transport path in a region of one of the circular path sections and on another side no curvature at all.

21. The device according to claim 16, wherein the outer side of the wedge element has a length in the range between 100 mm and 700 mm in the direction of the transport path.

22. The device according to claim 16, wherein the outer side of the wedge element comprises a curve, the curve being proportional to its length.

23. The device according to claim 16, wherein the outer side of the wedge element comprises a polynomial.

24. The device according to claim 16, wherein the wedge element has at least one finger.

25. The device according to claim 16, wherein the conveyor belt is in a region of at least one straight path section outwardly offset relative to a tangential connection between two adjacent wheels by a distance between 5 mm and 100 mm.

26. The device according to claim 21, wherein the length of the outer side of the wedge element is between 100 mm and 500 mm.
